(19) United States
(12) Patent Application Publication
(10) Pub. No.: US 2007/0078859 A1
(43) Pub. Date: Apr. 5, 2007

(54) Method, system, apparatus, and software product for an intelligent transfer log

(76) Inventor: Steve Arnold, Hampshire (GB)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/243,504

(22) Filed: Oct. 3, 2005

(51) Int. Cl. G06F 17/30

(52) U.S. Cl. 707/10

(57) ABSTRACT

A method, apparatus, system, and software product are disclosed for a mobile device to record successful transfer of media files to a second device. A connection is established between the mobile device and the second device, and the media files are transferred from the mobile device to the second device via the connection. The mobile device then receives from the second device a transfer log indicating successful transfer of the media files, and stores information from the transfer log in the mobile device.

### FIELD OF THE INVENTION

The present invention relates to transfer of multimedia information between phones and other nearby devices such as personal computers, set-top boxes, printers, and kiosks, which can connect to the phone and retrieve images, music, and the like from the phone.

### BACKGROUND OF THE INVENTION

Currently or in the near future, applications can access a wireless telephone via a personal computer (PC) suite or Universal Serial Bus Mass Storage Class USB-MSC, in order to transfer media files via a connection from the phone to a connected device such as the PC. However, the phone does not know what files have been transferred to the connected device after the connection has ended.

Some existing technologies are related to this general type of problem. For example, synchronisation such as SyncML is one similar technology. However, synchronisation is more closely related to making two data stores identical. The present invention differs in that it is directed at the problem of tracking what happens to media when it has left or been copied from the phone.

Another example of related technologies are IPOD-ITUNES AND IPOD-IPHOTO. According to those technologies, material is downloaded from the intelligent application (ITUNES/IPHOTO) to the relatively unintelligent IPOD. The ITUNES/IPHOTO applications know what material has been transferred to the IPOD because they are the applications that have loaded content onto the IPOD.

A further example of related technology is the Music Photo Video (MPV) standard. This is a technology/standard that could be used to solve the problem addressed by the present invention, but as yet the MPV technology has not been developed or used for this purpose. Further information about the MPV standard may be found at http://www.osta.org/mpv/public/index.htm (downloaded on Aug. 17, 2005). Other technologies may also be related to the present invention (e.g. Hi-Mat), but their specifications are currently only available under license, and so their capabilities are unclear.

Various patents already outline the use of a history file, though not in a way that addresses the problems that are solved by the present invention. For example, Koji (Japanese Patent No. 2001069296) addresses the problem of transmitting a highly operable untransferred image to a user while preventing the transfer of the same images by reading the transfer history information on the images which are transferred to the devices, and transferring en bloc the untransferred images to other devices by referring to the transfer history information when the images are transferred to other devices. Koji's solution is an image file consisting primarily of incidental data and image data. The incidental data includes transfer data and the photographing data. The transfer data includes transfer history information which shows whether a file is once transferred to a PC. Then ‘1’ and ‘0’ are set to the history information when a file is once transferred to the PC and not transferred yet to the PC respectively. When an electronic camera receives an image request command from a host application or the electronic camera transfers an image to the host application, a desired image file is first transmitted.

Koji essentially buries the history into the image file for each image, which presents several problems. For example, an external device has to read each image file to see if the image files have been transferred.

Another example of a patent that outlines the use of a history file is Nikawa (U.S. Pat. No. 6,668,134) which discloses an image recording device that uses a first recording medium to store image data photographed by an image photographing apparatus such as a digital camera, and uses a second recording medium which has a larger available storage capacity than the first recording medium. When the image data stored in the first recording medium is transferred into the second recording medium, history data corresponding to the image data to be transferred, is also transferred together. The history data is used for retrieval of the image data. Thus, the image recording device makes it possible to perform later image retrieval operations easily and conveniently. Nikawa thus requires a side file, which is only practical for some file types where it is not possible to fit the information into the file itself.

### SUMMARY OF THE INVENTION

The present invention provides a solution to the problem of a phone not knowing what files have been transferred to a connected device, by providing a transfer log that is returned to the phone. This invention describes a way for the connected device to describe in detail to the phone what has been successfully transferred. In this way the phone can present this information to the user after the connection has been terminated. For example the user can see what images/video clips have been transferred to his PC, or printed by a kiosk. Obviously this method also requires an application on the connected device that supports this solution.

According to this concept, for example, a user connects his or her phone to a PC. The PC then reads a Music Photo Video (MPV) manifest file to determine what content is on the phone that the PC has not already obtained. The PC then transfers only new content from the phone, and the PC writes back to the phone a transfer log file detailing what was transferred. The transfer log can be based on MPV, although that is not necessary for the purposes of the present invention. In any case, the phone reads the transfer log file, updates its internal database, and updates the manifest file. The novelty here is primarily in providing the transfer log after the image transfer has taken place. It is also novel to use the transfer log to detail in the manifest file what material has been transferred.

In this example, the phone is connected to a PC, but it could be connected to other devices such as a Hard Disk DVD recorder or the like. Note that a manifest file is a file that contains a list of all media files on the phone or memory card. Media files are still images, video, music, or the like.

### BRIEF DESCRIPTION OF THE DRAWINGS

FIG. 1 is a flow chart describing an embodiment of the present invention.

FIG. 2a is a block diagram of a mobile terminal according to an embodiment of the present invention.

FIG. 2a is a block diagram of a system according to an embodiment of the present invention.

FIG. 3a shows a basic case where new images are acquired by a phone and transferred via wireless or wire to a personal computer.

FIG. 3b shows the case of FIG. 3a except that a connection breaks.

FIG. 4a shows a basic memory card case where images are acquired by a phone and transferred via a memory card.

FIG. 4b shows the case of FIG. 4a except that the memory card is returned to a different phone.

FIG. 5a shows a case where new images are acquired by a phone, reduced in the phone, and transferred via wireless or wire to a personal computer.

FIG. 5b shows the case of FIG. 5a except that the images are reduced in the phone after transfer to the personal computer.

FIG. 6a shows a case where images are transferred from a personal computer to a phone.

FIG. 6b shows a case similar to FIG. 6a except that the images are reduced in the personal computer before transfer.

FIG. 6c shows a case similar to FIG. 6a except that the images are reduced in the phone after transfer.

### DETAILED DESCRIPTION OF THE INVENTION

According to an embodiment of the present invention, an easily transferable manifest file is created on the phone, based upon extensible markup language (XML). This manifest file details all media content on the phone, particularly filename, location, and possibly additional information such as file size and file date. For example, the manifest file would contain information like this:
Still_Image c:/images/cat.jpg
Still_Image c:/images/dog.jpg
Still_Image c:/images/holiday/bar.jpg
Video_Clip c:/videos/holiday/surfing.3gp
Music_track c:/music/grunge/lithium.m4a

When a PC connects to a phone, the PC reads the manifest file. The PC then finds all media content on the phone and transfers it to the PC. The PC then writes back a transfer log, to a known location in the phone. The transfer log details what has been transferred, where it was located on phone, and where the copy has been placed on the PC, plus the name of the PC and also the application that executed the transfer file. For example:
Transfer datetime=2004-12-17 13:55:30
Transfer device=HomePC
Transfer application=MyPhotoApplication
Still_Image from c:/images/cat.jpg to c:/my pictures/pets/cat.jpg
Still_Image from c:/images/dog.jpg to c:/my pictures/pets/dog.jpg
Still_Image from c:/images/holiday/bar.jpg to c:/mypictures/bondi/bar.jpg
Video_clip from c:/videos/holiday/surfing.3gp to c/mypictures/bondi/surfing.jpg
   The phone then reads the transfer log, and updates its internal database and also updates the manifest file. Suppose the user creates two more images (of a nightclub and a girl dancing). The manifest file becomes:
Still_Image c:/images/cat.jpg transferred to HomePC on 2004-12-17 13:55:30
Still_Image c:/images/dog.jpg transferred to HomePC on 2004-12-17 13:55:30
Still_Image c:/images/holiday/bar.jpg transferred to HomePC on 2004-12-17 13:55:30
Still_Image c:/images/holiday/nightclub.jpg
Still_Image c:/images/holiday/girldancing.jpg
Video_Clip c:/videos/holiday/surfing.3gp transferred to HomePC on 2004-12-17 13:55:30
Music_track c:/music/grunge/lithium.m4a transferred to HomePC on 2004-12-17 13:55:30
   Subsequently, the PC connects to the phone and reads the manifest file. The PC then determines that it only needs to transfer the two new image files nightclub.jpg and girldancing.jpg to the PC. Then the PC sends a new transfer log to the phone, and so the process repeats.

Alternatively, a global unique identification (GUID) could be used to augment or replace the file name to make it much more robust. For example, a still image GUID=123 . . . 876 is transferred to a Home PC on 2004-12-17 13:55:30. This helps, because a GUID may be the same even if the file name gets transferred. The approach just described is defined in MPV, but requires the addition of suitable means of generating a GUID, from a function such as MD5 which is a cryptographic hashing algorithm that is often used as part of a digital signature scheme. There is processor overhead in generating this GUID; also, the transferring application has to compare each GUID to the GUIDs of the content it has already transferred.

The advantages of employing a transfer log, as described by the present invention, are numerous. For example, transfer speeds can be improved, because once the manifest file has been transferred then only new content is transferred from the phone to a connected device (PC), rather than all content. This can have dramatic performance improvements over slow transport protocols (e.g. Bluetooth and infrared).

Another advantage of the present invention is that a manifest file is relatively lightweight and should be easy to generate and process. There is no direct application to application communication. Moreover, a transfer log is easy to generate. Both the manifest file and the transfer log can be handled by a low performance processor such as in a set-top box.

Additionally, the phone can keep track of where content has been transferred to, and display this to the user. The user may then decide to keep only a thumbnail image on the phone, but the properties of the thumbnail can detail the last known location of the full resolution copy.

A further advantage of the present invention is that it can handle transfers to different storage devices. For example, the user might transfer some images to a home PC, and some images to a work PC (depending on context), or even to a friend's television set-top box for sharing.

The scheme of the present invention can be used not just for storage in a PC memory or other storage device, but can also be extended for printing, uploading to the web, and the like. For example, the user may connect his phone to a photo kiosk, and the kiosk displays images, and then the user selects several of those images to print, which subsequently are printed. The kiosk then sends back a log file to the phone detailing what images have been printed.

The present invention will work outside of the phone. For example, a user takes out a memory device (such as a memory card) which has the manifest file located in the memory card. The use then places the memory card in a memory card reader, and transfers images from the memory card to a PC or kiosk. The PC or kiosk then writes back a transfer log to the memory card, and subsequently the user puts the memory card back into the phone. The phone reads the transfer log, and updates the phone's database.

The present invention can be extended by marking images in the manifest file for a specific purpose, for example, “print these files”. When placed in a kiosk, the kiosk can present the marked images to the user, for printing.

The present invention can be further enhanced by having a robust unique identification rather than relying on file name, date and size. MPV provides a means to do this using the MD5 algorithm.

Additionally, the present invention can be extended to support over the air (OTA) transport, for example at low rate times (off peak). Here, the network end application can get (or be sent) the manifest file, and can determine what files are needed to be transferred. That way, the necessary files are transferred across the expensive OTA transport.

The present invention relies upon implementing applications. It is possible that an application external to a phone receives images and does not put back a transfer log. However, the user may obtain and enhanced experience by using external devices that have compatible applications.

A user may move files on a PC after the transfer log has been sent back to the phone. This means that the destination address is no longer valid. However, MPV has a concept called last URL which accepts that the locations can change, but provides a clue to the user. Furthermore, a user may delete files on PC, so in this case the phone says files have been transferred but they are no longer available on the PC.

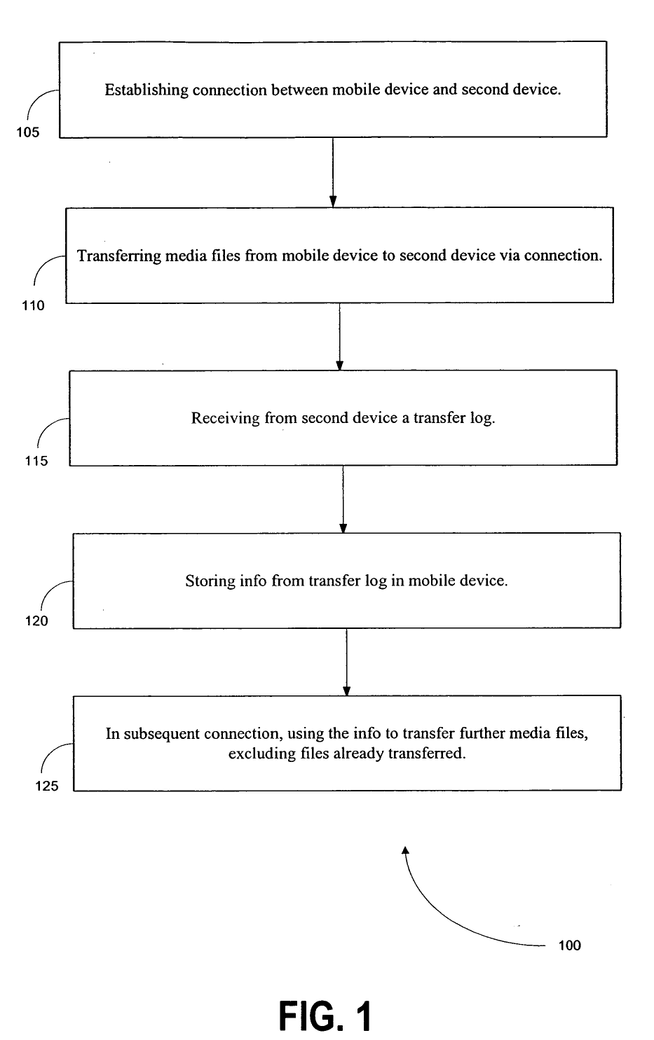

The accompanying figures show examples of how this invention can be implemented according to various embodiments thereof. As seen in FIG. 1, a method 100 begins by establishing 105 a connection between a mobile device and a second device. Then, media files are transferred 110 from the mobile device to the second device via the connection. Subsequently, a transfer log is received 115 from the second device, and information from the transfer log is stored 120 in the mobile device. In a subsequent connection between the mobile device and the second device, the aforementioned information is used 125 to exclude files already transferred from a subsequent transfer of further media files.

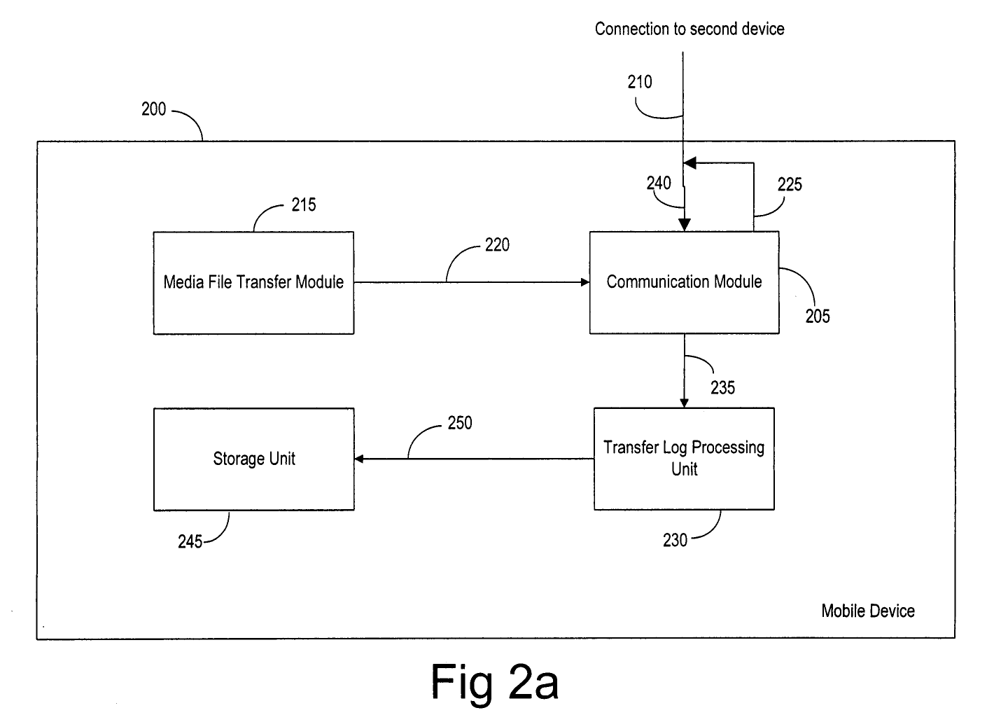

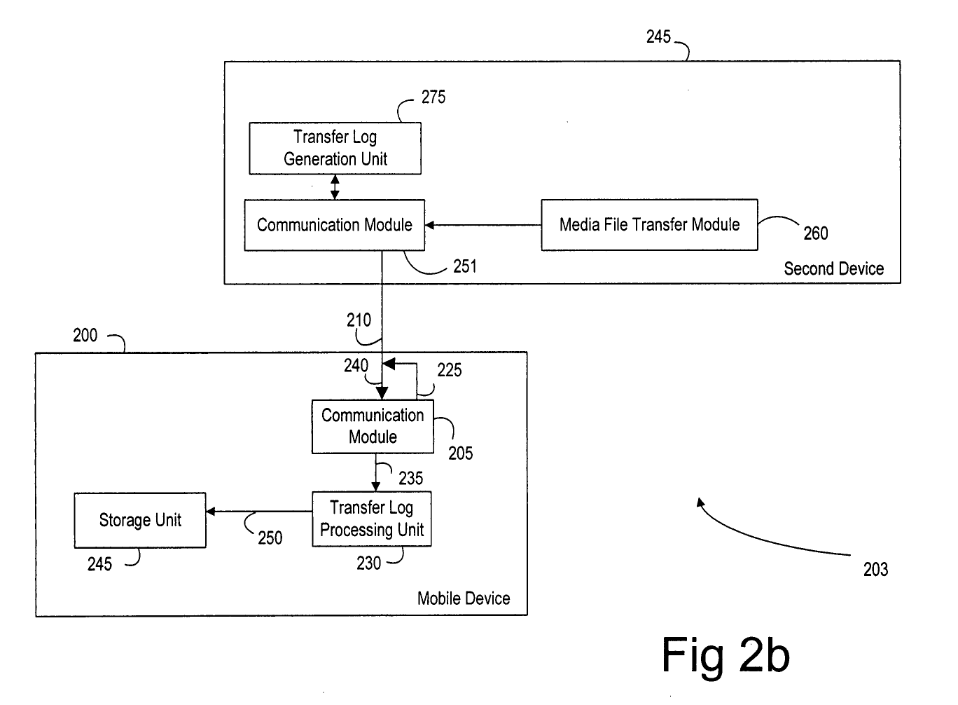

FIG. 2a shows a mobile device 200 such as a wireless phone, according to an embodiment of the present invention. The communication module 205 is operatively connected to an antenna 210 which communicates with a second device, such as a PC, via cellular communication, or via non-cellular communication such as Bluetooth, an infrared link, usb, or wlan. A media file transfer module 215 transfers media files along the line 220 for transfer to the second device along the line 225. A transfer log processing unit 230 receives along the line 235 a transfer log from the communication module 205, indicating successful transfer of the media files. This transfer log arrived at the communication module 205 from the second device, along the line 240. A storage unit 245 stores information sent to it along the line 250 from the transfer log processing unit 230, which has extracted that information from the transfer log.

Although the media file transfer module 215 is shown as being within the mobile device 200, it can also be within the attached device (PC) which actually is a more likely location. If the media file transfer module is at the phone, then the phone pushes images off of the phone. But, if the media file transfer module is at the PC, then the PC pulls images off of the phone.

FIG. 2b illustrates a system 203 according to the present invention, consisting of the mobile device 200 that was already shown in FIG. 2a, but without a media file transfer module in the mobile device. Instead, FIG. 2b shows that the second device 245 contains the media file transfer module 260. Additionally, the second device 245 includes the transfer log generation unit 275, and a communication module 251 that can communication with the mobile device's communication module 205.

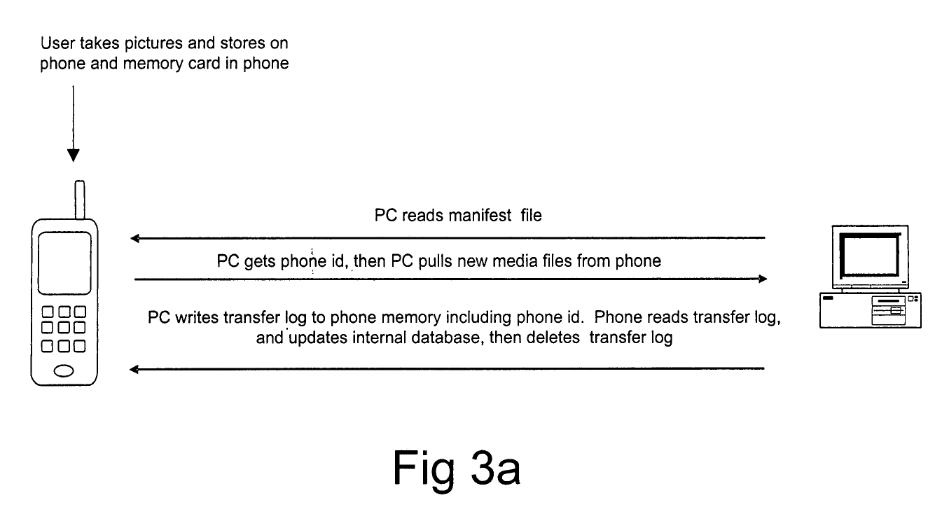

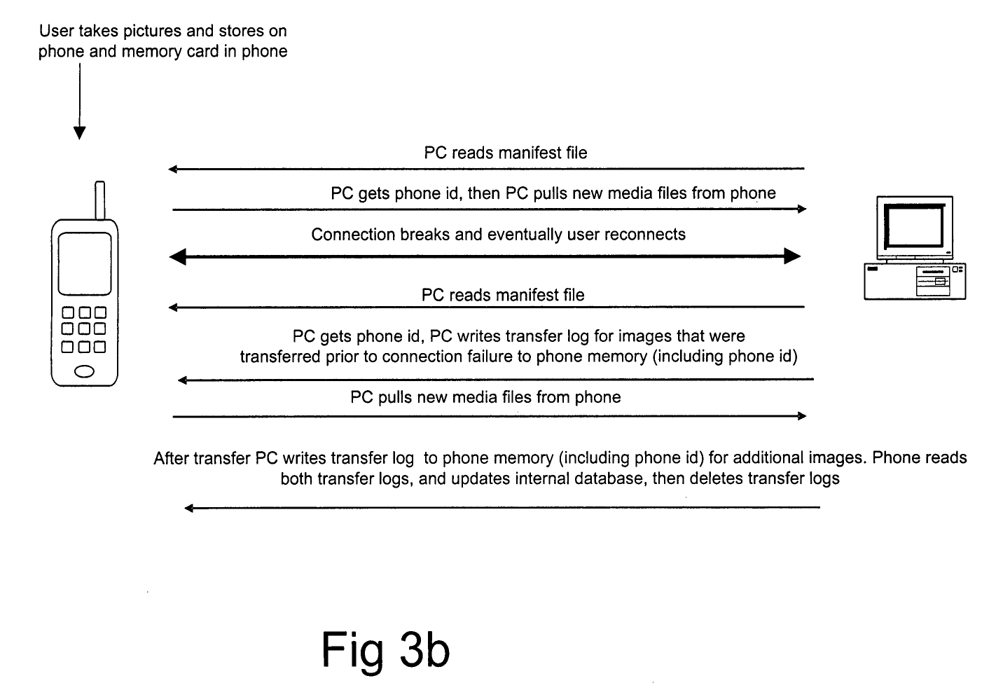

FIG. 3a illustrates a basic case where new images become available on a phone, when a user takes pictures using a camera, and the pictures are stored on the phone and the phone's memory card. The camera may, for example, be part of the phone, or it may be an additional user device. In any event, the user connects to a PC via connected transport (e.g. universal serial bus or Bluetooth), and the PC pulls content from the phone to the PC. FIG. 3b illustrates a similar basic case to FIG. 3a, except that the connection breaks. The PC is able to remember the old transfer that was broken, and also remembers which phone was involved in the connection problem.

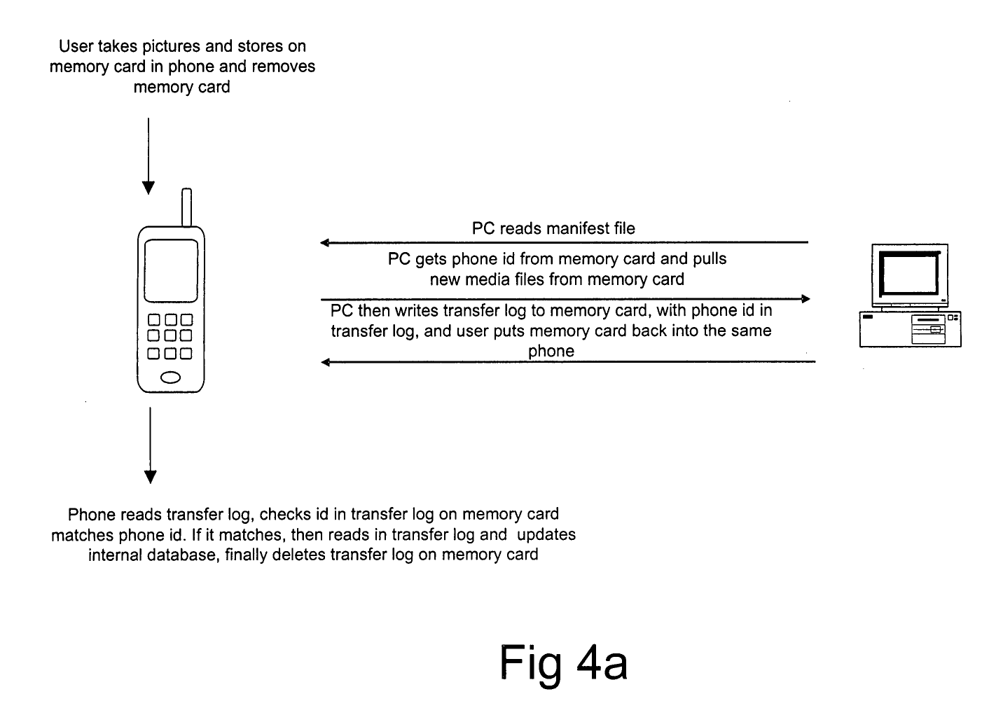

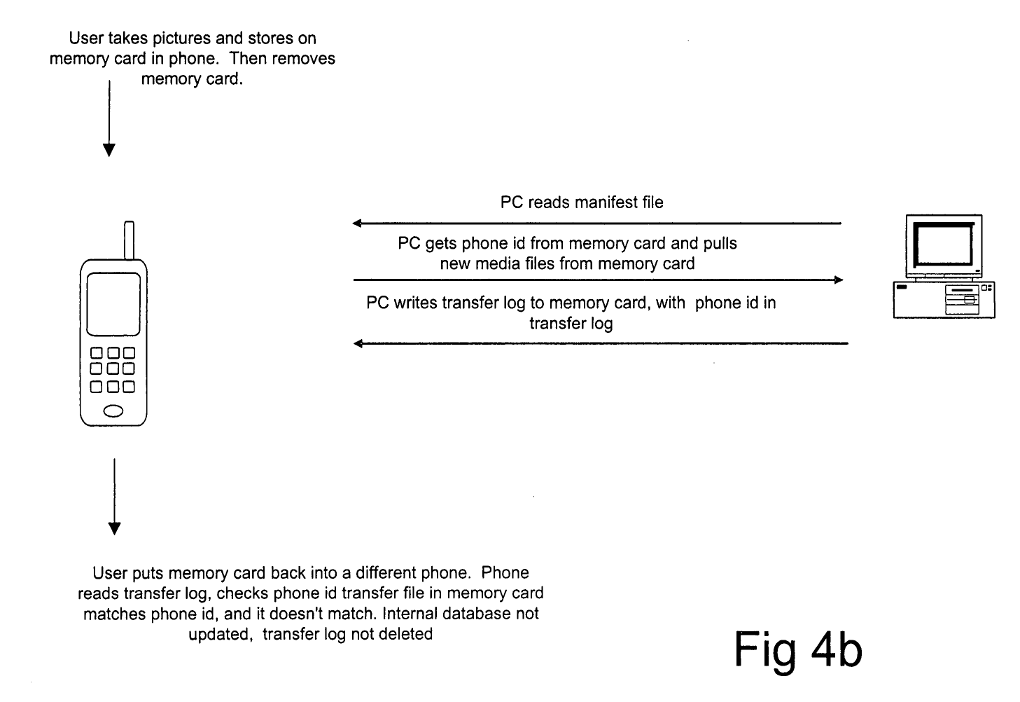

FIG. 4a illustrates a situation where new images are put on a memory card at the phone, when the user takes pictures using a camera. The user then removes the memory card from the phone, and inserts it into a memory card reader. The PC reads the memory card, and then the user returns the memory card to the same phone. FIG. 4b illustrates a situation similar to FIG. 4a, but the user returns the memory card to a different phone.

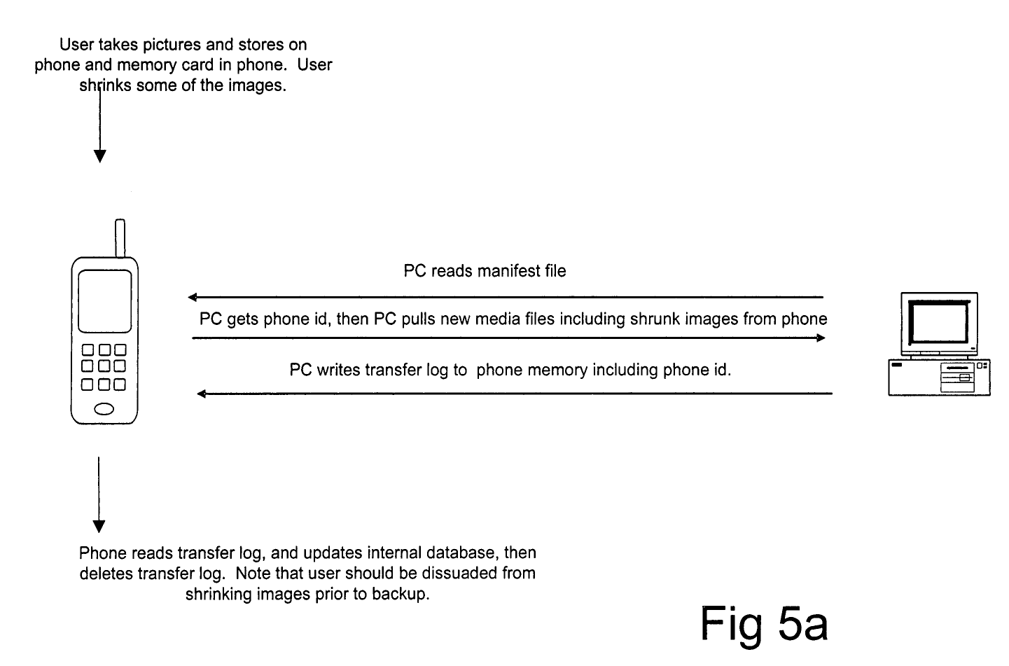

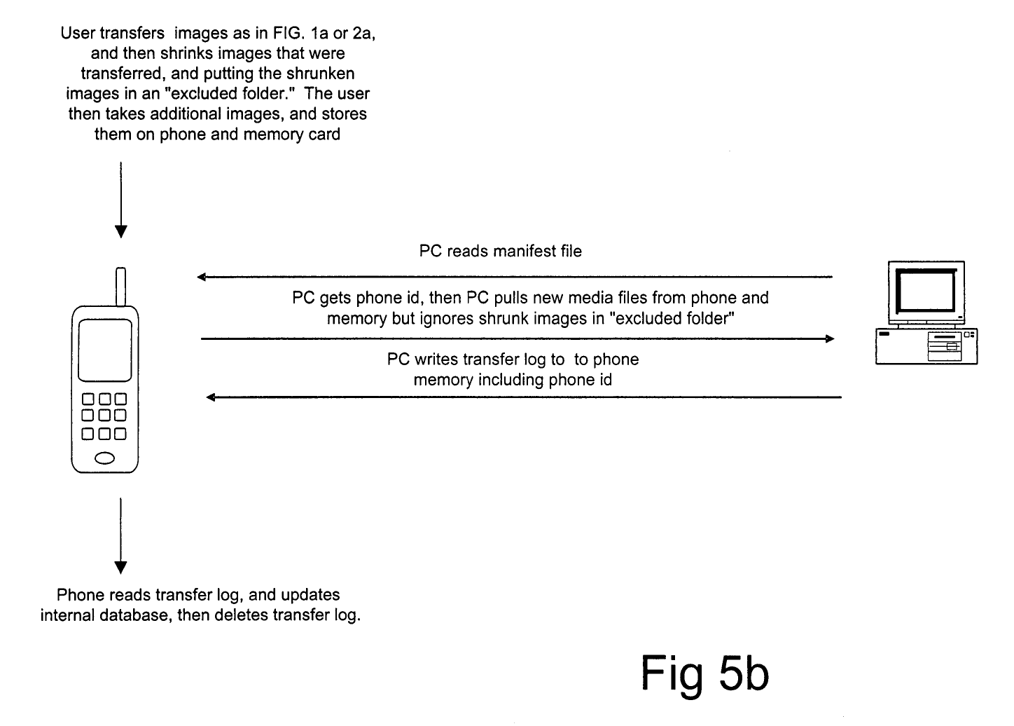

FIG. 5a illustrates a situation where a user reduces (i.e. shrinks) image size of pictures after acquiring them with a camera, and stores them on a phone/memory card. After reducing the image size, the phone connects to a PC via connected transport (e.g. USB or Bluetooth), and the PC pulls content from the phone to the PC. FIG. 5b illustrates a situation where images are acquired and stored as described by FIG. 3a or 4a, and then the user shrinks some of these image that have been transferred, so that they occupy less space in the phone/memory card. Then the user connects to a PC, which pulls the image content to the PC.

It is noted that a token file is used to tell the PC that the phone will read a transfer log if one is put onto the phone. The token file also tells the PC where to put the transfer log (i.e. which directory). If the phone does not have a token file, then the PC would not put a transfer log onto the phone, because that might fill up the phone's memory, if the phone does nothing with those transfer logs. If a phone has a manifest file, then this may wrap up the token file within it. So, a manifest file would state to the PC “I will read transfer logs,” and here is a list of my files.

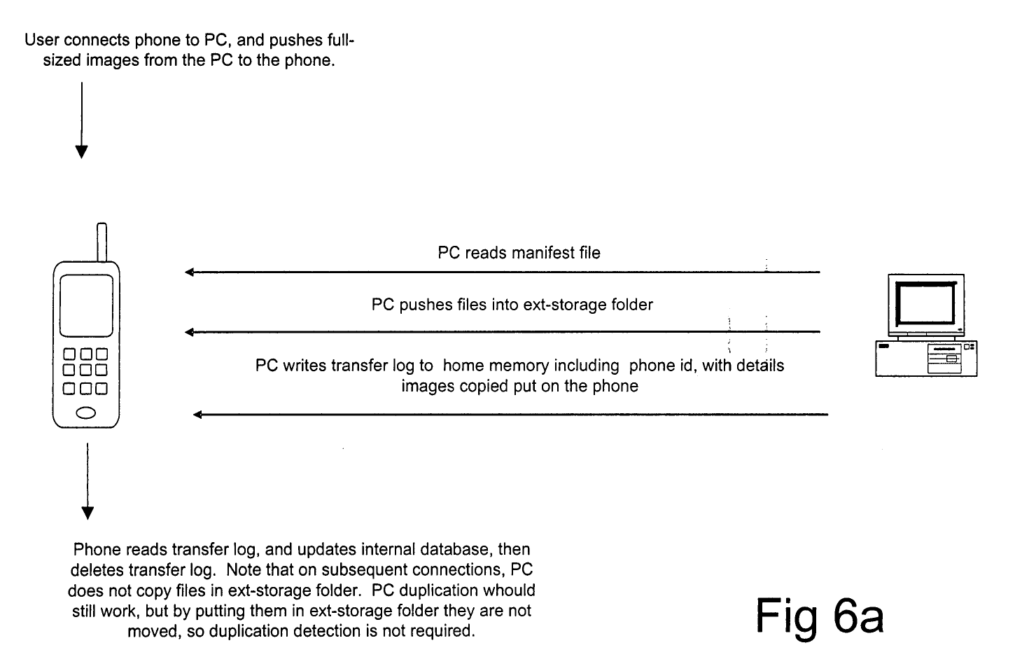

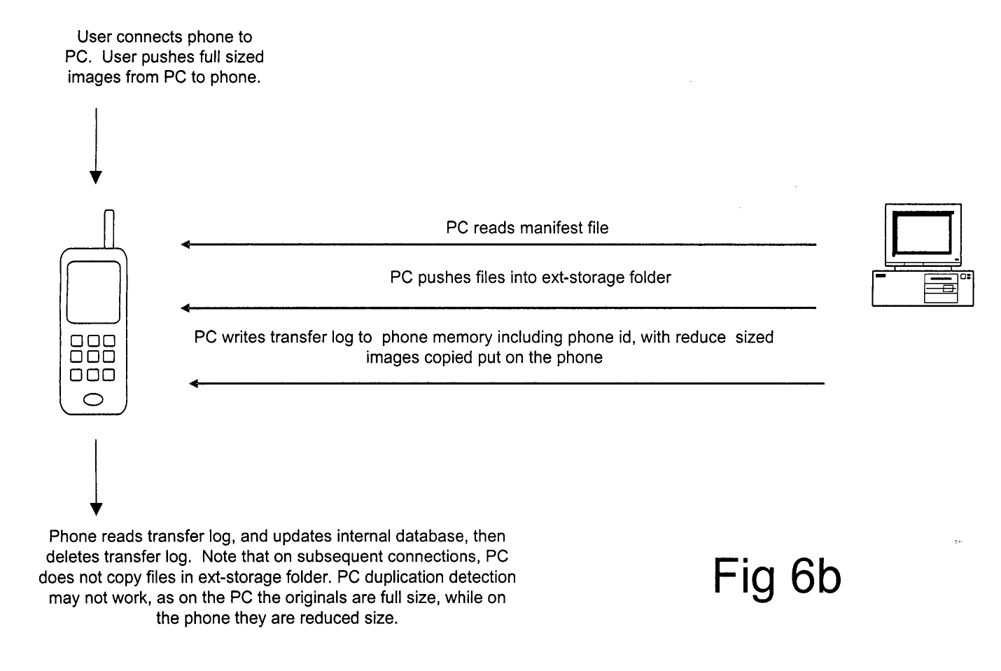

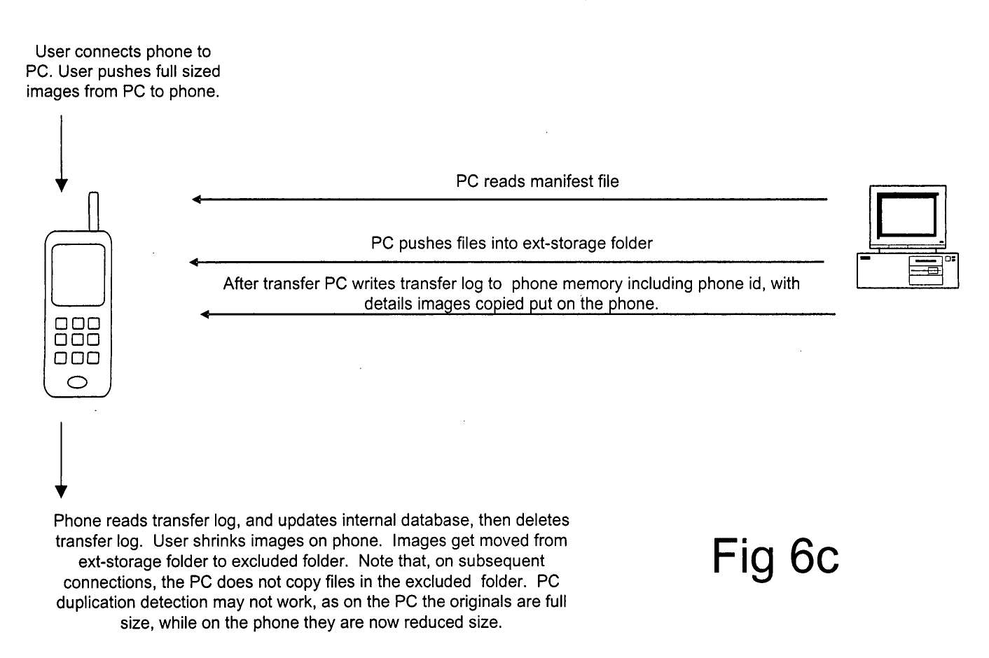

FIG. 6a illustrates a user connecting to a PC, and transferring full-sized images from the PC to the phone, and FIG. 6b shows instead the case where the transferred images are reduced-size images. FIG. 6c illustrates a type of scenario similar to FIG. 6a, and also involves shrinking the image size on the phone.

It is to be understood that all of the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method for a mobile device to record successful transfer of media files to a second device, comprising the steps of:
establishing a connection between the mobile device and the second device;
transferring the media files from the mobile device to the second device via the connection;
receiving from the second device a transfer log indicating successful transfer of the media files; and
storing information from the transfer log in the mobile device.

2. The method of claim 1, further comprising the steps of:
ending the connection;
establishing a subsequent connection between the mobile device and the second device;
accessing the information from the transfer log to identify the media files that were already transferred;
transferring a further set of media files, excluding the media files that were already transferred from the mobile device to the second device;
receiving from the second device a further transfer log indicating successful transfer of the further set of media files; and
storing further information from the further transfer log in the mobile device.

3. The method of claim 2, wherein at least one of the further set of media files was acquired in the mobile device subsequent to the step of ending the connection.

4. The method of claim 1, further comprising the step of providing information to a user as to which of a plurality of files have been transferred to which of a plurality of transferee devices.

5. The method of claim 1, wherein the step of storing the information includes updating a manifest file to indicate the media files that have been transferred.

6. The method of claim 2, wherein the step of accessing the information is performed by reading a manifest file that has been updated to include the information from the transfer log.

7. The method of claim 1, wherein the media files include at least one file type from the group consisting of still images, video and music.

8. The method of claim 1, wherein transferring the media files creates copies while leaving the mobile device with copies or originals of the media files.

9. The method of claim 1, wherein the transfer log details the media files that have been transferred, details where within the mobile device it has been transferred from, and details where within the second device it has been transferred to.

10. The method of claim 1, further comprising the steps of:
choosing at least one of the media files for deletion from the mobile device; and
creating at least one thumbnail of the at least one of the media files for deletion,
wherein the thumbnail has properties that detail a last known location of a full resolution copy of the at least one of the media files.

11. A mobile device for recording successful transfer of media files to a second device, the mobile device comprising:
communication module for connecting between the mobile device and the second device;
transfer log processing unit, for receiving via the communication module from the second device a transfer log indicating successful transfer of the media files; and
storage unit for storing information from the transfer log in the mobile device,
wherein the media files are transferred from the mobile device to the second device via the communication module, by a media file transfer module.

12. The mobile device of claim 11, wherein the media file transfer module is located at the second device instead of at the mobile device.

13. The mobile device of claim 11:
wherein the communication module is also for establishing a subsequent connection between the mobile device and the second device;
wherein the media file transfer module is also for accessing the information from the transfer log to identify the media files that were already transferred, and for transferring a further set of media files excluding the media files that were already transferred from the mobile device to the second device;
wherein the transfer log processing unit is also for receiving from the second device a further transfer log indicating successful transfer of the further set of media files; and
wherein the storage unit is also for storing further information from the further transfer log in the mobile device.

14. The mobile device of claim 13, wherein at least one of the further set of media files was acquired in the mobile device subsequent to the step of ending the connection.

15. The mobile device of claim 11, further comprising a user interface for providing information to a user as to which of a plurality of files have been transferred to which of a plurality of transferee devices.

16. The mobile device of claim 11, wherein the transfer log processing unit is also for updating a manifest file to indicate the media files that have been transferred.

17. The mobile device of claim 11, wherein the media file transfer module accesses the information by reading a manifest file that has been updated to include the information from the transfer log.

18. The mobile device of claim 11, wherein the media files include at least one file type from the group consisting of still images, video and music.

19. The mobile device of claim 11, wherein the media file transfer module is for transferring the media files by creating copies while leaving the mobile device with copies or originals of the media files.

20. The mobile device of claim 11, wherein the transfer log has details of the media files transferred, of where within the mobile device the media files been transferred from, and of where within the second device the media files have been transferred to.

21. The mobile device of claim 11, further comprising:
deletion means for choosing, or allowing to be chosen, at least one of the media files for deletion from the mobile device; and
a thumbnail generator for generating at least one thumbnail of the at least one of the media files that is deleted,
wherein the thumbnail has properties that detail a last known location of a full resolution copy of the at least one of the media files.

22. The mobile device of claim 11, wherein the communication module comprises a removable memory device readable by both the mobile device and the second device.

23. The mobile device of claim 11, wherein the communication module comprises a transceiver device for wireless communication between the mobile device and the second device.

24. A system for recording successful transfer of media files, the system comprising:
a mobile device containing a plurality of media files; and
a second device, for communicating with the mobile device via a connection;
wherein the mobile device is for transferring the media files to the second device via the connection;
wherein the second device is for providing a transfer log to the mobile device, indicating successful transfer of the media files; and
wherein the mobile device is also for storing information from the transfer log.

25. A software product for use in a mobile device, the software product comprising a computer readable medium having executable codes embedded therein; the codes, when executed, adapted to carry out the steps of:
establishing a connection between the mobile device and a second device;
transferring media files from the mobile device to the second device via the connection;
receiving from the second device a transfer log indicating successful transfer of the media files; and
storing information from the transfer log in the mobile device.
